(19) United States
(12) Patent Application Publication
(10) Pub. No.: US 2026/0030766 A1
(43) Pub. Date: Jan. 29, 2026

(54) CONTINUOUS FLOW ESTIMATION FOR DYNAMIC SCENES

(71) Applicant: QUALCOMM Incorporated, San Diego, CA (US)

(72) Inventors: Ming-Yuan YU, Austin, TX (US); Varun RAVI KUMAR, San Diego, CA (US); Senthil Kumar YOGAMANI, San Diego, CA (US)

(21) Appl. No.: 18/784,269

(22) Filed: Jul. 25, 2024

(51) Int. Cl. G06T 7/246

(52) U.S. Cl. CPC G06T 7/248; G06T 2207/10016; G06T 2207/10028; G06T 2207/20081; G06T 2207/20084; G06T 2207/30236

(57) ABSTRACT

Certain aspects of the present disclosure provide flow estimation techniques for dynamic scenes. A method generally includes obtaining a first time series sequence of sample sets of a scene (including a first and a second set of samples) over a first period of time associated with a reference time; processing, with a spatial-temporal attention module, the first time series sequence, to generate a modified first time series sequence of sample sets of the scene comprising the first set and not the second set of samples; processing, with a first neural ordinary differential equation (ODE) and a first ODE solver, the modified first time series sequence to predict a second time series sequence of sample sets; and generating a first output indicating a predicted flow of the scene from the reference time to a first selected time based on the modified first time series sequence and the second time series sequence.

### INTRODUCTION

### Field of the Disclosure

Aspects of the present disclosure relate to flow estimation techniques for dynamic scenes.

### DESCRIPTION OF RELATED ART

Scene flow describes the three-dimensional (3D) motion of a dynamic scene. For example, scene flow may provide information about the spatial arrangement and rate of change of points in a dynamic environment (e.g., such as an intersection, an airport, etc.). In some cases, scene flow may provide 3D vectors, representing the per-point 3D motion between two or more consecutive frames. A “point” (e.g., one example of a “sample,” as used herein) may refer to a data point in a 3D coordinate system representing a single spatial measurement on a surface (e.g., such as an object's surface) in the scene. Accurate scene flow estimation may be key to identifying dynamic objects and predicting their motions in a dynamic scene.

Scene flow estimation plays an important role in many applications, including autonomous driving and robotics, to name a few, enabling machines to perceive and navigate through their environments. For example, in autonomous driving, scene flow estimation may help vehicles understand the 3D structure and motion of the surrounding environment, which may be important for making safe and informed decisions. Similarly, in robotics, scene flow estimation may assist robots in navigating through complex environments by providing a 3D understanding of the scene.

Some methods perform scene flow estimation using two-dimensional (2D) representations, such as monocular and/or binocular image sequences. The methods, however, may need to recover the 3D motion from 2D data, thereby making the process of scene flow estimation indirect. Moreover, the 2D images acquired by an image sensor, such as a camera, may be easily disturbed by the changes in external environments, including weather and illumination, which may reduce the accuracy of scene flow estimation in real-world applications.

### SUMMARY

One aspect provides a method for flow estimation by an apparatus, comprising: obtaining a first time series sequence of sample sets of a scene over a first period of time associated with a reference time, wherein the first time series sequence comprises a first set of samples and a second set of samples; processing, with a spatial-temporal attention module trained for sample partitioning, the first time series sequence, to generate a modified first time series sequence of sample sets of the scene comprising the first set of samples and not the second set of samples; processing, with a first neural ordinary differential equation (ODE) trained to model flow estimation and a first ODE solver, the modified first time series sequence to predict a second time series sequence of sample sets of the scene over a second period of time; and generating a first output indicating a predicted flow of the scene from the reference time to a first selected time based on the modified first time series sequence and the second time series sequence.

Another aspects provides a method for flow estimation training by an apparatus, comprising: initializing one or more first weights for a spatial-temporal attention module; initializing one or more second weights for a first neural ODE and a second neural ODE; obtaining a plurality of training input time series sequences of sample sets of a training scene, wherein: each respective training input time series sequence comprises a respective set of first training samples and a respective set of second training samples; and each respective training input time series sequence is associated with a respective training reference time; for each respective training input time series sequence: processing, with the spatial-temporal attention module, the respective training input time series sequence to generate: a respective first modified training input time series sequence comprising the respective set of first training samples and not the respective set of second training samples; and a respective second modified training input time series sequence comprising the respective set of second training samples and not the respective set of first training samples; processing, with the first neural ODE and a first ODE solver, the respective first modified training input time series sequence to predict a respective first training output time series sequence of sample sets; generating a respective first training output indicating a respective first predicted flow of the training scene from the respective training reference time to a respective second selected time based on the respective first modified training input time series sequence and the respective first training output time series sequence; processing, with the second neural ODE and a second ODE solver, the respective second modified training input time series sequence to predict a respective second training output time series sequence of sample sets; generating a respective second training output indicating a respective second predicted flow of the training scene from the respective training reference time to the respective second selected time based on the respective second modified training input time series sequence and the respective second training output time series sequence; determining a respective loss value based on the respective first training output and the respective second training output; and based on the respective loss value, modifying the one or more first weights and the one or more second weights.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts example scene flow estimation using three-dimensional (3D) point clouds.

FIG. 2A depicts an example workflow for training a spatial-temporal attention module and a neural ordinary differential equation (ODE) to perform flow estimation for dynamic scenes.

FIG. 2B depicts example training input and output when training a spatial-temporal attention module and a neural ODE to perform flow estimation for dynamic scenes.

FIG. 3 depicts an example workflow for flow estimation using a spatial-temporal attention module, a neural ODE, and an ODE solver.

FIG. 4 illustrates an example artificial intelligence (AI) architecture.

FIG. 5 depicts an example method of flow estimation by an apparatus.

FIG. 6 depicts an example method for flow estimation training by an apparatus.

FIG. 7 depicts aspects of an example device configured to perform flow estimation for dynamic scenes.

### DETAILED DESCRIPTION

Aspects of the present disclosure provide apparatuses, methods, processing systems, and computer-readable mediums for scene flow estimation using 3D samples of a scene and a neural ordinary differential equation (ODE). Details related to the neural ODE are provided below. In certain aspects, scene flow estimation, as described herein, includes identifying dynamic samples (e.g., representing moving samples over time) and static samples (e.g., representing non-moving samples over time), and using only the dynamic samples as input to the neural ODE to reduce the computational complexity for scene estimation. In certain aspects, point clouds generated by light detection and ranging (LiDAR) sensor(s) are used for scene flow estimation, and more specifically, dynamic points (e.g., representing moving points over time) identified in point clouds generated for a scene may be used to estimate the dynamics (e.g., flow) of the scene. Though certain aspects are described with respect to point clouds generated by LiDAR sensor(s), the techniques discussed herein may also be applicable to other sets of samples (e.g., points, pixels, etc.) corresponding to a scene. The samples may be generated by one or more sensors.

To overcome the technical challenges associated with using 2D image data for scene flow estimation, some other methods focus on estimating scene flow from 3D representations, such as 3D point clouds (simply referred to herein as “point clouds”). For example, 3D sensors, such as LiDAR sensor(s), may be used to produce point clouds, which are collections of points (e.g., associated with objects and/or surfaces) in 3D space for a scanned environment. 3D scene flow aims at estimating the scene flow at discrete timestamps based on point cloud(s), such as generated via the LiDAR sensor(s).

In particular, LiDAR-based sensors may generate point clouds for a scene at a fixed frequency, independent of the dynamics in a scene. As an illustrative example, LiDAR-based sensor(s) may be used to generate a point cloud representing the 3D locations of points in a scene every x seconds over a period of time to capture explicit 3D motions of the points in the scene at specific times over the period of time. The point clouds may be used as input to a trained machine learning (ML) model to predict the positions of the points, every x seconds in the future, to predict one or more future point clouds used to represent the scene (e.g., the temporal resolution of the predicted point clouds may be the same as the temporal resolution of the input point clouds). 3D scene flow may include finding the point-wise 3D displacement between corresponding points in consecutive point clouds. The point-wise 3D displacement across point clouds (e.g., generated at discrete timestamps), may provide a discrete approximation of the continuous flow of points (e.g., associated with one or more objects) in the scene.

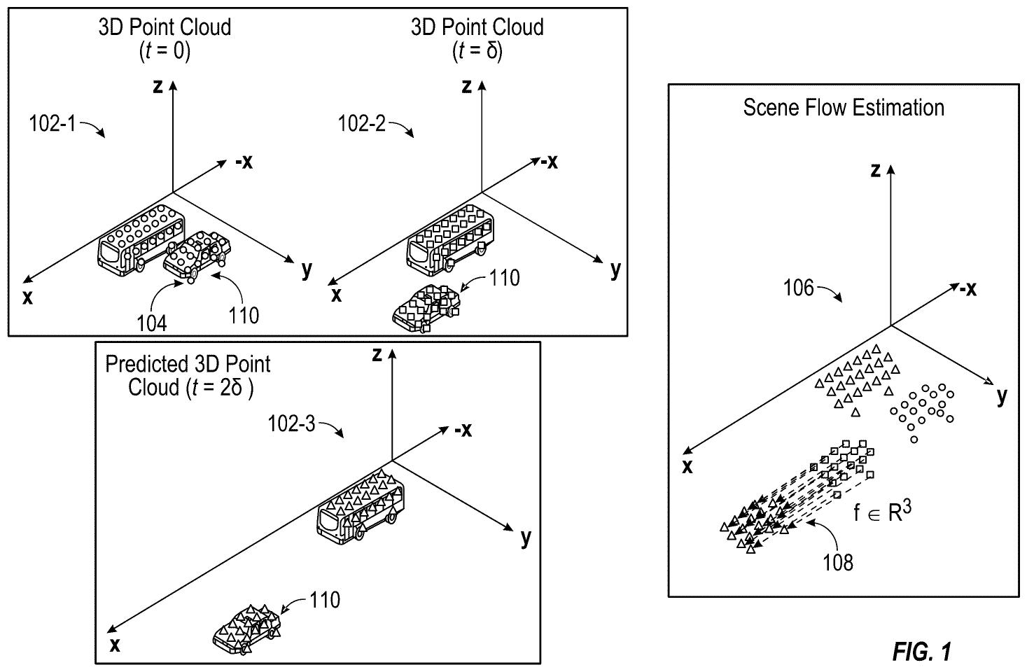

FIG. 1 depicts example scene flow estimation based on 3D point clouds associated with a scene. For example, a 3D point cloud 102-1 may be generated to include points 104 associated with surfaces in the scene. 3D point cloud 102-1 may be generated, using a LiDAR sensor, to represent the scene at time t=0. After a δ amount of time has passed (e.g., a fixed amount of time has passed), another 3D point cloud 102-2 may be generated, using the LiDAR sensor, to represent the scene at time t=δ. As shown in FIG. 1 at time t=δ, a vehicle 110 may have moved along an x-axis in the scene; thus, points 104 associated with the surface of vehicle 110 may be in different positions in 3D point cloud 102-2 than in 3D point cloud 102-1.

3D point cloud 102-1 and 3D point cloud 102-2 may be used to predict point cloud 102-3. 3D point cloud 102-3 may represent the predicted locations of points 104 at time t=2δ (e.g., a δ amount of time in the future).

To illustrate the motion of the points 104 from 3D point cloud 102-2 to 3D point cloud 102-3, a translational vector 108, ƒ, may be created for each point 104 in 3D point cloud 102-2 and its corresponding point 104 in 3D point clouds 102-3. The collection of all translation vectors 108, ƒ, may represent the scene flow 106 for the scene between time t=δ and time t=2δ.

The use of 3D LiDAR sensor(s), in point cloud-based methods, may help to directly estimate flow fields in a 3D space and effectively overcome the loss of 3D structure information in expanding from 2D to 3D (e.g., as in image-based methods). Additionally, 3D LiDAR sensor(s) may be less sensitive to illumination, as well as weather changes, and thus may be more suitable for use in more types of scenes for flow estimation, such as outdoor environments.

While point-cloud-based scene flow estimation provides the aforementioned benefits, such techniques are not without limitations. For example, the use of point clouds, based on discrete timestamps, to estimate scene flow is a challenging problem in real-world scenes.

For example, point clouds generated using a first time step (e.g., generated every 15 seconds) and used to predict the motion of one or more points in a scene may allow for the generation of point clouds representing points in the future with a same time step (e.g., predicted every 15 seconds). Put differently, a temporal resolution of input point clouds may match (e.g., may be equal to) a temporal resolution of point clouds predicted for a scene. Scene flow estimated based on point clouds associated with discrete timestamps may result in a sparse, discrete approximation of the continuous flow of the scene. Accordingly, the predicted flow may inaccurately represent the flow in the scene, at least due to the discrete estimates missing some important motion(s) of one or more points between such timestamps.

For example, a predicted first point cloud may estimate positions of points in a scene at time t=0 seconds, a predicted second point cloud may estimate positions of points in a scene at time t=15 seconds, and a predicted third point cloud may estimate positions of points in a scene at time t=30 seconds. The scene may be associated with a busy intersection. The predicted flow of a vehicle (e.g., represented by multiple points in the scene) between the first point cloud (e.g., at t=0 seconds) and the second point cloud (e.g., at t=15 seconds) may indicate that a vehicle in the scene is likely to cross the intersection during the 15 second period of time, or put differently, transition from point A to point B where point A is at one side of the intersection and point B is at another side of the intersection. The predicted flow, however, may fail to capture any motion of the vehicle during the 15 second period of time. For example, to avoid a pothole when crossing the intersection, the vehicle may swerve into a left lane and then return to its original lane after passing the pothole. This lane change may happen between when the vehicle is expected to be at point A and when the vehicle is expected to be at point B. Due to the discrete nature of the point clouds, however, this motion of the vehicle may not be captured. Thus, the flow estimate of the vehicle using the point clouds captured at discrete timestamps may not accurately predict the continuous motion of the vehicle over a future period of time.

In certain aspects, the flow estimated for a scene may also be inaccurate due to, at least, the inability of such techniques to identify the intention(s) of point(s) and/or goal(s) of agents (e.g., associated with multiple points in a scene, such as a pedestrian) in the scene and consider such intention(s) and/or goal(s) when estimating the scene flow. A point intention may refer to the implicit state of a point used to infer resulting motion(s) of the point. An agent goal may refer to a target location of the agent and may be predicted/inferred based on the agent's movements. For example, a pedestrian may be represented as one or more points in a scene. Understanding a tendency of the pedestrian to cross a road in the scene (e.g., an example intention of points(s) in the scene, while the other side of the road may represent an example target location or goal of the pedestrian) may result in more accurate scene flow estimation, at least with respect to the pedestrian's predicted motion. Point clouds, obtained at discrete timestamps, however, may only capture explicit 3D motions of points between timestamps and thus, may not possesses this information. For example, point clouds may capture geometric motions of points (e.g., associated with one or more objects) but may lack information about object(s) associated with the points in the scene, their affordances, expected behaviors, etc. Affordances may refer to the possible actions of agents in the scene. For example, affordances of vehicles and/or two-wheelers in the scene may be constrained to motion in the longitudinal direction, given it may not be possible for vehicles and/or two-wheelers to move sideways in the scene. Accordingly, the ability to accurately predict flow estimation for a scene may be limited. For example, some point-cloud-based scene flow estimation methods may predict (e.g., using point clouds which lack information about the affordances of vehicles) that one or more vehicles in the scene may be moving sideways from time t=0 to time t=δ, which may be physically implausible.

Another technical problem associated with some point-cloud-based scene flow estimation techniques includes their inability to leverage temporal context and/or interactions between points over time. Accordingly, awareness of the spatial-temporal context in the scene may be limited when estimating the scene flow.

Point-cloud-based scene flow estimation techniques may assume that point cloud data is captured from spatially and temporally close viewpoints, such as consecutive scans of a LiDAR. Under this assumption the scene/object surfaces which the point clouds represent may not drastically change between view points and may be generally consistent. However, in some cases, the assumption of temporal and spatial proximity in point cloud capture may be invalid. In particular, a large temporal distance between point cloud capture may result in significant changes in the scene. This may lead to large inconsistencies between the point clouds. Inconsistency between the point clouds may also be due to noise in sensor data and/or differences in the underlying surfaces. Due to a lack of temporal coherence and/or physical constraints between captured point clouds, such inconsistencies may be inevitable. Accurately estimating the flow in a dynamic scene may be a challenging task with inconsistent point clouds.

Some scene flow estimation methods, based on point cloud sequences, may struggle to handle the high-dimensional and uncertain nature of real-world scenes. That is, accurate point cloud generation and per-point flow estimation may be computationally expensive and may not scale well for complex scenarios with large amounts of data, such as complex urban driving environments with many dynamic objects (e.g., dynamic points). As the complexity of a scene increases, the computational burden may also grow, making it difficult for some scene flow estimation methods to provide outputs in real-time.

Certain aspects described herein overcome the aforementioned technical problems associated with current scene flow estimation techniques and provide a technical benefit to the field of computer vision. For example, aspects described herein provide techniques for continuous flow estimation for dynamic scenes using a trained neural ODE and an ODE solver (e.g., a fixed, known algorithm).

A neural ODE is an ODE defined by a neural network. More specifically, an ODE is an equation relating a function ƒ of one variable to its derivatives, such as ƒ(x, y, y′, y″, . . . , yⁿ), where variable x is interpreted as time, and y is a quantity that changes over time. Thus, a neural ODE is a neural network that may be used to approximate dynamic scenes that change over time and whose evolution can be described by differential equations. For example, the dynamics of a scene may be modeled as an ODE:

$$\frac{dx}{dt} = f ( t , x ( t ) )$$

$$where$$

$$x ( t ) = [ P ( t ) , P ( t - 1 ) , … , P ( t - k + 1 ) ]$$

and f represents the learned neural network, t represents a particular time, x(t) represents a state vector at the time t including a sequence of point clouds collected for the scene (e.g., P(t) represents a point cloud at time t, k represents the length of the point cloud sequence (e.g., point clouds from t to [(t-k)+1)), and dx/dt represents the rate of change of the state vector x(t) over time. This ODE may represent how the state vector x(t), containing the point clouds, evolves continuously over time, as modeled by the function ƒ(t,x(t)) output by the trained neural ODE (e.g., neural network). Thus, the state of a scene at any moment in time may be approximated. For example, an ODE solver may take the function ƒ(t,x(t)) output by the trained neural ODE and numerically integrate x(t) forward in time, thus outputting x(t) at any timestamp t.

For example, given an input sequence of scene level point clouds, xᵢₙ, representing the initial state of the scene at time t₀=0, a neural ODE and ODE solver may predict the evolution of the state x of the scene (e.g., predict the propagation of the state x of the scene) up to time t₁=T in the future (e.g., predict the state of the scene between t₀ and t₁). Put differently, the neural ODE and the ODE solver may estimate the scene dynamic continuously from time t₀=0 (e.g., where state x=xᵢₙ) to an end time t₁=T. Based on this estimate, any future point cloud x(t) representing the scene at time t in the future (e.g., where 0≤t≤T), may be predicted (e.g., using the ODE solver). The scene flow at any time t may be determined by comparing the predicted point clouds, x(t), to the point clouds representing the initial state of the scene, xᵢₙ. For example, scene flow at time t may be estimated as:

$$SceneFlow ( t ) = x ( t ) - {x}_{in}$$

This predicted scene flow may be used for one or more downstream tasks, such as motion planning.

In certain aspects, the neural ODE is trained to predict the future state of a scene, as a sequence of point clouds, based on an input sequence of point clouds modified to include only dynamic samples within the scene. For example, to reduce the input dimensions to the neural ODE, a spatial-temporal attention module may be used to generate multiple attention maps, each indicating a tendency of activity for points in the input sequence of point clouds. The attention maps may be used to then segment the input sequence of point clouds into (1) a first modified input sequence of the point clouds including dynamic points (and not static points in the scene) and (2) a second modified input sequence of point cloud include static points (and not dynamic points in the scene). Dynamic points may represent points that change their location (e.g., 3D location) one or more times over a period of time, while static point may represent points that do not change their location over the period of time (e.g., remain in a same location over the period of time). Because static points are expected not to move and/or change over time, only the first modified input sequence of the point clouds may be provided as input into the neural ODE to predict the future state for the scene for scene flow estimation.

As used herein, a spatial-temporal attention module is a module that incorporates attention mechanism(s) to selectively identify and focus on salient points in an input sequence of point clouds, such as dynamic points, which represent the flow of a scene over time. For example, a spatial-temporal attention module may be trained to generate a spatial attention map by assigning different weights and/or scores to different points in the input sequence of point clouds. These weights and/or scores may indicate how much the model should pay attention to each point in the input, and a larger weight and/or score assigned to a point may identify a point that a neural ODE should focus on. For example, a larger weight and/or score may be assigned to dynamic points, while a smaller weight and/or score may be assigned to static points. The weights and/or scores may then be used to partition the input sequence of point clouds into two sequences of point clouds, e.g., one sequence of point clouds including only dynamic points and one sequence of point clouds including only static points.

In certain aspects, the spatial-temporal attention module and the neural ODE are jointly trained to (1) perform sample selection (e.g., select important points within an input sequence of point clouds for processing by the neural ODE) and (2) perform model flow estimation. For example, the spatial-temporal module may partition an input sequence of training point clouds into a first sequence of point clouds including dynamic training points and a second sequence of point clouds including static training points. The neural ODE (later used for scene flow estimation, as described above) may predict a first set of point clouds in the future over a period of time using the first sequence of point clouds, and another ODE may predict a second set of point clouds in the future over the period of time using the second sequence of point clouds. A loss value may be calculated using a loss function configured to at least (1) increase loss based on a similarity between the predicted first and second sets of point clouds and (2) increase loss based on the second set of point clouds indicating some level of motion for the static training points (e.g., static training points are expected to remain consistent over time). This loss value may be used to modify at least weights of the spatial-temporal attention to better distinguish dynamic points from static points, such that only dynamic points from a scene are provided as input into the neural ODE for scene flow estimation. This type of training may be referred to herein as “contrastive learning,” where points are juxtaposed against each other to teach the spatial-temporal attention module which points are similar and which are different.

Modeling the scene flow as a continuous ODE helps to overcome limitations of prior discrete, per-frame methods used to estimate flow in dynamic scenes, as described in detail above. For example, a neural ODE modeling flow estimation may enable new capabilities for understanding dynamic environments. Specifically, neural ODEs may be able to model not only explicit changes in a scene (e.g., such as changes in 3D positions of points), but also implicit changes, such as intention(s) of different point(s) and/or goal(s) of different agent(s) (e.g., associated with multiple points) in the scene. Modeling implicit states of different points may provide insight into (1) dynamic behaviors of points, as well as (2) interactions between points in the scene. Being able to model and interpret point intentions and/or agent goals may allow for better prediction of future behaviors and interactions for different points in the scene thereby enhancing the understanding of the scene's dynamics. As an illustrative example, the use of neural ODEs to model flow estimation may allow for accurate and realistic predictions of drivers on the road, and more specifically, intentions and/or goals of drivers when operating vehicles, which may be useful for designing more socially acceptable autonomous vehicles.

Another technical advantage over methods used for discrete approximation of continuous scene flow, includes a neural ODE's ability to model flow in a dynamic scene as a continuous-time dynamical system. This allows for estimating scene flow at any arbitrary time with infinite resolution, thereby providing a more accurate and detailed motion representation for the scene. In particular, the output temporal resolution of a sequence of point clouds predicted by the neural ODE (and an ODE solver) may be different than a temporal resolution of a sequence of point clouds used as input into the neural ODE. Further, the temporal evolution of scene flow may be more accurately modeled based on an ability of the neural ODE to leverage temporal context from multiple past point clouds, e.g., a sequence of point clouds provided as input into the neural ODE.

Other technical advantages associated with use of a neural ODE to model scene flow estimation include its (1) robustness to noise and (2) ability to handle complex dynamics. Further, solving an ODE may be computationally efficient. Thus, using a neural ODE to model flow estimation may be scalable to large point cloud sequences and real-time applications, including applications associated with challenging urban driving environments with many dynamic objects.

Although aspects herein are described with respect to the use of point clouds for flow estimation, in some other aspects, other types of input samples sets, such as a sequence of 2D images captured over a period of time (e.g., where pixels in the 2D images represent the samples analyzed by the spatial-temporal attention module and the neural ODE), may be provided as input to a neural ODE to estimate flow for a dynamic scene.

Additionally, although aspects herein may be used to model the flow of dynamic points over time, in certain other aspects, a neural ODE may be further configured to model the dynamic nature of (1) risk-inducing points for risk assessment and/or (2) points associated with noise for noise removal. These different embodiments are described in detail below.

### Aspects Related to Training a Spatial-Temporal Attention Module and a Neural ODE to Perform Flow Estimation for Dynamic Scenes

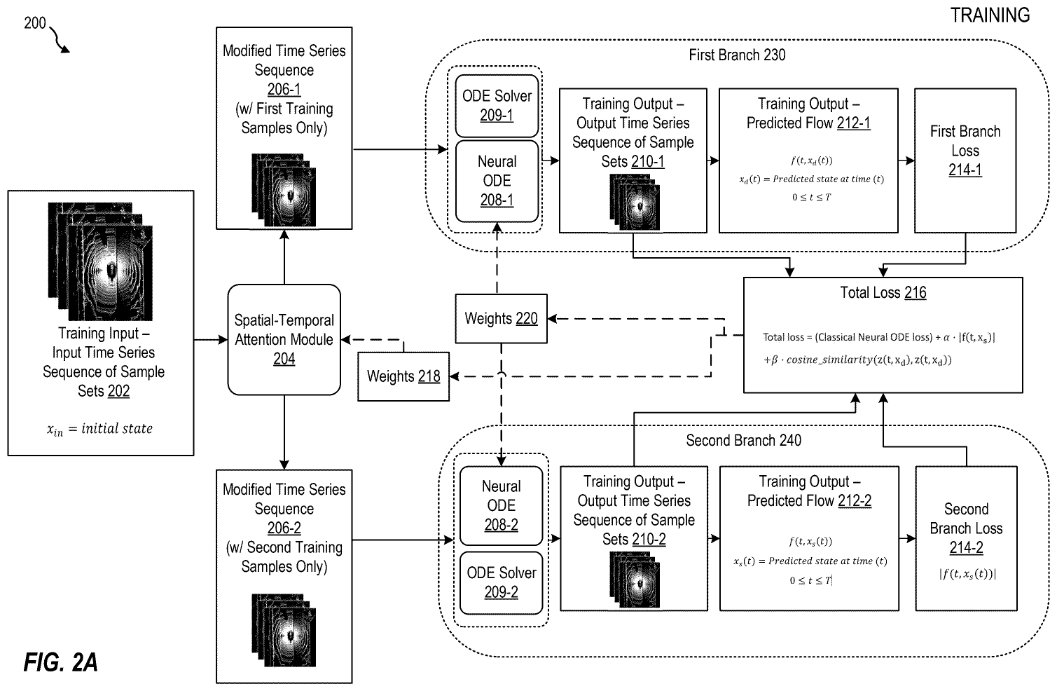

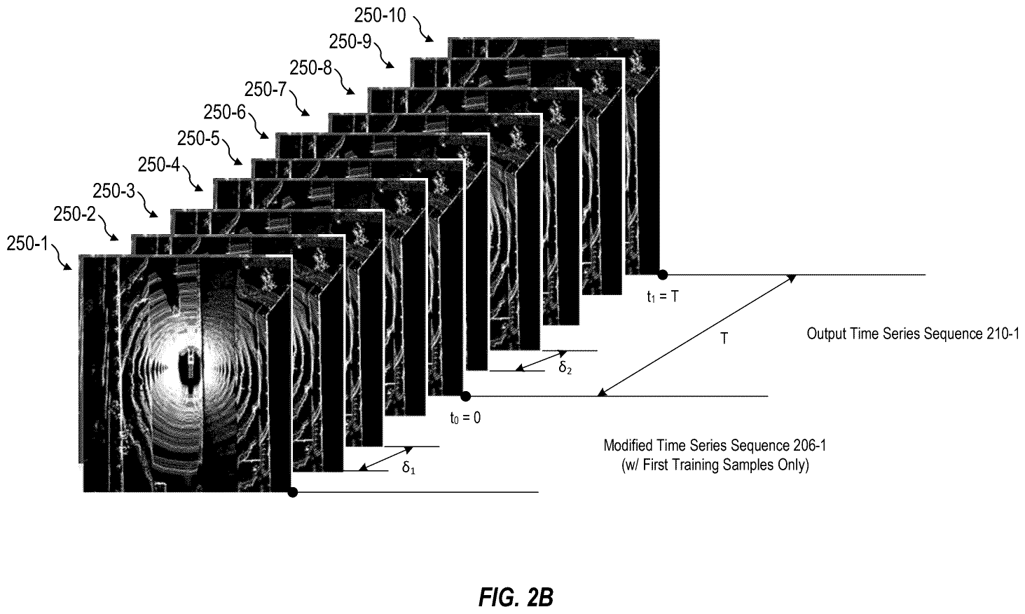

FIG. 2A depicts an example workflow 200 for training a spatial-temporal attention module 204 and a neural ODE 208-1 (e.g., a first neural ODE) to perform flow estimation for dynamic scenes. More specifically, workflow 200 may be used to train the spatial-temporal attention module to perform sample selection to thereby partition an input time series sequence of a sample set 202 (simply referred to herein as “an input time series sequence 202”) (e.g., including one or more samples) into two modified time series sequences 206-1, 206-2 (e.g., with first training samples and second training samples, respectively). Further, workflow 200 may be used to train neural ODE 208-1 to model flow estimation for a scene using the modified time series sequence 206-1. Further, workflow 200 may train a neural ODE 208-2 (e.g., a second neural ODE) to perform flow estimation for the scene such that an output of neural ODE 208-2 can be used to determine a loss value that can be used to modify weights for spatial-temporal attention module 204 and/or first neural ODE 208-1.

To provide an illustrative example, workflow 200 may be described with respect to an example use case where the spatial-temporal attention module 204 is used to partition the input time series sequence 202 into (1) modified time series sequence 206-1 including only dynamic samples and (2) modified time series sequence 206-2 including only static samples. Further, a first branch 230 of the network, used for processing by the first neural ODE, may be a “dynamic branch” where dynamic samples are analyzed for predicting the future state of the scene. A second branch 240 of the network, used for processing by the second neural ODE 208-2, may be a “static branch” where static samples are analyzed for predicting the future state of the scene. It is noted, however, that in some other examples, the partitioning performed by the spatial-temporal module 204 and/or the branches of the network may be different. Put differently, workflow 200 may be generalized and used for other applications, such as risk assessment and/or noise removal, in addition or alternative to scene flow estimation.

For example, in certain aspects, the spatial-temporal attention module 204 may be used to partition the input time series sequence 202 into (1) modified time series sequence 206-1 including only risk-inducing samples and (2) modified time series sequence 206-2 including only non-risk-inducing samples. Example risk-inducing samples may include samples associated with surfaces of incoming traffic in a scene, while example non-risk-inducing samples may include samples associated with surfaces of parked vehicles. Further, a first branch 230 of the network, used for processing by the first neural ODE, may be a “risk-inducing branch” where risk-inducing samples are analyzed for predicting the future state of the scene. A second branch 240 of the network, used for processing by the second neural ODE 208-2, may be a “non-risk-inducing branch” where non-risk-inducing samples are analyzed for predicting the future state of the scene. The risk-inducing branch and the non-risk-inducing branch may have distinct properties in motion.

As another example, in certain aspects, the spatial-temporal attention module may be used for noise removal in adverse weather conditions. For example, spatial-temporal module 204 may be used to partition the input time series sequence 202 into (1) modified time series sequence 206-1 including only samples associated with noise and (2) modified time series sequence 206-2 including only samples not associated with any noise. Example noisy samples may include reflections from snowflakes moving with an ego vehicle (e.g., a vehicle that contains the sensors that perceive the environment around the vehicle and may be used to create example sample sets), while example non-noisy samples may include samples associated with object(s) in the scene that do not move with the ego vehicle. Further, a first branch 230 of the network, used for processing by the first neural ODE, may be a “noisy branch” where noisy samples are analyzed for predicting the future state of the scene. A second branch 240 of the network, used for processing by the second neural ODE 208-2, may be a “non-noisy branch” where non-noisy samples are analyzed for predicting the future state of the scene. The noisy branch and the non-noisy branch may have distinct properties in motion.

Further, to provide an illustrative example, workflow 200 may be described with respect to the use of point clouds for flow estimation. Specifically, input time series sequence 202, modified time series sequence 206-1, modified time series sequence 206-2, an output time series sequence of a sample set 210-1, and an output time series sequence of a sample set 210-2 may each be a sequence of point clouds. Each point cloud may include multiple points. Each point cloud may be an example of a “sample set,” while each point in a respective point cloud may be an example of a “sample” of the respective sample set. It is noted however that workflow 200 may use other time series sequences of sample sets such as a time series sequence of 2D images. Specifically, each 2D image may be an example of a “sample set,” while each pixel in a respective 2D image may be an example of a “sample” of the respective sample set.

Prior to beginning workflow 200, weights 218 for spatial-temporal attention module 204 may be initialized. Further, weights 220 for neural ODE 208-1 and neural ODE 208-2 may be initialized. Neural ODE 208-1 and neural ODE 208-2 may use the same weights 220.

Further, prior to beginning workflow 200, a plurality of training data instances may be obtained. Each training data instance may include a training input and a training output. The training input may be an input time series sequence of sample sets (e.g., such as input time series sequence of sample sets 202 in FIG. 2) over a first period of time. The training output may be an output time series sequence of sample sets over a second period of time, which is later in time than the first period of time. As described above, at least for this example, the training input and the training output may each include a series of point clouds, each with multiple points associated with surfaces in a scene.

Workflow 200 begins with selecting one of the training data instances. In this example, the training data instance including input time series sequence 202 may be selected. Input time series sequence 202 may be an input sequence of scene-level point clouds, xᵢₙ, representing the initial state of the scene at time t₀=0 (referred to herein as a “reference time” associated with input time series sequence 202). For example, input time series sequence 202 may include a sequence of k point clouds, from time t₀ to (t₀-k+1):

$${x}_{in} ( {t}_{0} ) = [ P ( {t}_{0} ) , P ( {t}_{0} - 1 ) , … , P ( {t}_{0} - k + 1 ) ]$$

Each point cloud may include multiple training points. The training points may include first training points and/or second training points. For example, input time series sequence 202, xᵢₙ, may include first training points and second training points, where the first training points represent dynamic points in the point clouds and the second training points represent static points in the point clouds.

In certain aspects, the k point clouds of input time series sequence 202 include additional information related to the points included in the point clouds. For example, the point clouds may include intensity information for one or more of the first training points or the second training points (e.g., intensity information for a training point associated with a surface of a stop sign in a scene may indicate a high intensity due to the bright red color of the stop sign). As another example, the point cloud may include location information of one or more of the first points or the second points. The intensity information and/or location information, when provided, may allow for better detection of such points over a period of time for more accurate scene flow estimation.

Workflow 200 proceeds with spatial-temporal attention module 204 processing input time series sequence 202 to generate modified time series sequence 206-1 and modified time-series sequence 206-2. For example, to reduce the input dimensions to neural ODE 208-1 and neural ODE 208-2, spatial temporal module 204 may generate a plurality of attention maps, each attention map indicating a tendency of activity for each sample of one or more samples in the first set of samples and the second set of samples. The attention map may indicate an activity of a training sample (e.g., a point) by assigning a weight to the sample. Training samples with higher weights may represent dynamic training samples, while training samples with lower weights may represent static training samples. Accordingly, the attention map may be used to segment input time series sequence 202 samples into first training samples (e.g., dynamic training samples) and second training samples (e.g., static training samples). The first training samples may be captured in modified time series sequence 206-1, x_{d} (also represented herein as x_{d}(t₀) or x_{d}(0) associated with time t₀=0), and the second training samples may be captured in modified time series sequence 206-2, xₛ (also represented herein as xₛ(t₀) or xₛ(0) associated with time t₀=0).

For example, x_{d} may include a sequence of point clouds, where:

$${x}_{d} [ t ] = \{ {x}_{in} [ t ] [ i ] if attention\_map [ t ] [ i ] > threshold , for all 0 < i < num\_points [ t ] \} ,$$

$$for all - k < t <= 0$$

where k represents a time horizon (e.g., such as ten sample sets or point clouds), t represents a particular timestamp and i represents a particular sample index. In particular, x_{d} may include a sequence of point clouds with points having an assigned weight greater than the threshold.

Similarly, xₛ may include a sequence of point clouds, where:

$${x}_{s} [ t ] = \{ {x}_{in} [ t ] [ i ] if attention\_map [ t ] [ i ] \leq threshold , for all 0 < i < num\_points [ t ] \} ,$$

$$for all - k < t <= 0$$

Put differently, xₛ may include a sequence of point clouds with points having an assigned weight less than or equal to the threshold. By partitioning input time series sequence (e.g., input training point clouds), xᵢₙ, into modified time series sequence 206-1, x_{d}, and modified time series sequence 206-2, xₛ, the numbers of samples (e.g., points) in each sequence may be reduced by 10%-90%, depending on the actual scene captured (e.g., a highway, an urban area, etc.).

In certain aspects, to reduce the dimensions even further, modified time series sequence 206-1, x_{d}, and/or modified time series sequence 206-2, xₛ, may be pillarized (e.g., via pillarization), at least in example cases where the motion of points in the scene are represented in 2D (e.g., bird's eye view (BEV)). Pillarization refers to a technique for discretizing samples (e.g., 3D points) in a BEV. For example, each sample (e.g., point) in modified time series sequence 206-1, x_{d}, in a BEV (e.g., having a 10 cm×10 cm resolution) may have a corresponding x and y coordinate. Each sample (e.g., point) in modified time series sequence 206-1, x_{d}, may be assigned to a nearest cell in a 2D grid based on their respective x and y coordinates. After assignment of all of the samples, each cell may be referred to as a “pillar,” given each cell may include multiple neighboring samples having similar x and y coordinates. Compared to another grid-based representation, such as 3D voxels, pillars may be 2D and thus, may be more computationally efficient than using 3D voxels. Pillarization may be used herein to speed up the computation for flow estimation training and/or prediction.

For first branch 230 (e.g., the dynamic branch), workflow 200 proceeds with neural ODE 208-1 and an ODE solver 209-1 processing modified time series sequence 206-1 to predict an output time series sequence of sample sets 210-1 (simply “output time series sequence 210-1”). In certain aspects, feature extraction is performed to extract implicit states (e.g., z(t, x_{d})) from modified time series sequence 206-1, x_{d}, and use these implicit states to predict the output time series sequence 210-1. The implicit states may include information about intentions of points and/or interactions between points in modified time series sequence 210-1, x_{d}. In certain aspects, the implicit states (e.g., z(t, x_{d})) may be used to infer resulting motions of the different points to determine movement of one or more agents (e.g., associated with the points) in the scene for determining goal(s) of the agent(s).

Output time series sequence 210-1 may include a sequence of sample sets, or point clouds in this example, that represent the state of the scene from the reference time, t₀=0, to time t₀=T (e.g., a period of time, T, in the future). More specifically, the sample sets (e.g., point clouds) may represent motion of dynamic samples in the scene between time 0-T. A temporal resolution (δ₂) of output time series sequence 210-1 may be the same as or different than a temporal resolution (δ₁) of modified time series sequence 206-1.

For example, as shown in FIG. 2B, modified time series sequence 206-1 may include point clouds 250-1 through 250-5. The point clouds 250-1 through 250-5 may be associated with reference time t₀=0. A temporal resolution (δ₁) of modified time series sequence 206-1 may represent a first time step between each point cloud 250 in modified time series sequence 206-1. Output time series sequence 210-1 may include point clouds 250-6 through 250-10 predicted using neural ODE 208-1 and ODE solver 209-1 (shown in FIG. 2A). The point clouds 250-6 through 250-10 may represent the motion of dynamic points within the scene between reference time t₀=0 and time t₁=T. A temporal resolution (δ₂) of output time series sequence 210 may represent a second time step between each point cloud 250 in output time series sequence 210.

The temporal resolution (δ₂) of output time series sequence 210-1 may be different than a temporal resolution (δ₁) of modified time series sequence 206-1. In certain aspects, the temporal resolution (δ₂) of output time series sequence 210-1 may be chosen to be relatively small (e.g., δ₂=0.01) to provide a more accurate depiction of the motion of points in the scene over time T.

For training, in certain aspects, temporal resolution (δ₂) of output time series sequence 210-1 may be selected to be a temporal resolution that results in point clouds being predicted for time stamps between time t₀=0 and time t₁=T that can be compared to point clouds of the training data instance selected (e.g., point clouds collected at various timestamps using 3D sensor(s), such as LiDAR sensor(s)).

Returning to FIG. 2A, for the dynamic branch 230, a predicted flow 212-1 at time t (e.g., 0≤t≤T) may be determined using the input time series sequence 202 and output time series sequence 210-1. For example, the state of the scene at time t may be estimated as (e.g., using ODE solver 209-1):

$${x}_{d} ( t ) = ODEsolver ( f , {x}_{in} , {t}_{0} = 0 , {t}_{1} = T )$$

and the scene flow at time t may be estimated by comparing x_{d}(t) to x_{d}(0):

$$SceneFlow ( t ) = {x}_{d} ( t ) - {x}_{d} ( 0 )$$

A first branch loss 214-1, representing classical neural ODE loss, may be determined based on the scene flow at time t and/or the predicted state of the scene at time t. For example, ƒ(t, x_{d}) may be used to obtain first branch loss 214-1, where ƒ is the learned neural network model (e.g., neural ODE 208-1 outputs a function ƒ(t, x_{d}), where t is any timestamp). In certain aspects, the predicted state of the scene at a particular time t may be compared to the actual state of the scene at time t (e.g., represented as a point cloud collected via 3D sensor(s) in the scene) associated with the selected training data instance.

Similarly, for second branch 240 (e.g., the static branch), workflow 200 proceeds with neural ODE 208-2 and an ODE solver 209-2 processing modified time series sequence 206-2 to predict an output time series sequence of a sample set 210-2 (simply “output time series sequence 210-2”). Output time series sequence 210-2 may include a sequence of sample sets, or point clouds in this example, that represent the state of the scene from the reference time, t₀=0, to time t₀=T (e.g., a period of time, T, in the future). More specifically, the sample sets (e.g., point clouds) may represent motion of static samples in the scene between time 0-T. A temporal resolution (δ₂) of output time series sequence 210-2 may be the same as or different than a temporal resolution (δ₁) of modified time series sequence 206-1.

A predicted flow 212-2 at time t (e.g., 0≤t≤T) may be determined using the input time series sequence 202 and output time series sequence 210-2. For example, the state of the scene at time t may be estimated as (e.g., using ODE solver 209-2):

$${x}_{s} ( t ) = ODEsolver ( f , {x}_{in} , {t}_{0} = 0 , {t}_{1} = T )$$

and the scene flow at time t may be estimated by comparing xₛ(t) to xₛ(0):

$$SceneFlow ( t ) = {x}_{s} ( t ) - {x}_{s} ( 0 )$$

Because xₛ(t) represents the state of static samples in the scene at time t, xₛ(t) is expected to be the same as xₛ(0), thereby indicating no flow/motion for the static samples between time 0-t. Thus, if motion (e.g., scene flow) is determined for the static samples, then a loss value may be increased. For example, a second branch loss 214-2 may be determined based on ƒ(t, xₛ) representing the overall motion of the point cloud at time t for the scene with only static samples (e.g., neural ODE 208-2 outputs the function ƒ(t, xₛ), where t is any timestamp). Second branch loss 214-2 may be increased when ƒ(t, xₛ) indicates one or more of the static samples have moved (e.g., indicating an incorrect prediction by neural ODE 208-2 and/or incorrect partitioning of static and dynamic samples by spatial-temporal module 204).

A total loss 216 may be calculated based on at least first branch loss 214-1 and second branch loss 214-2. For example, total loss 216 may be calculated as:

$$Total Loss = ( First Branch Loss ) + α \cdot ( Second Branch Loss ) + β \cdot cosine\_similarity ( z ( t , {x}_{d} ) , z ( t , {x}_{s} ) )$$

$$or$$

$$Total Loss = ( Classical neural ODE loss ) + α \cdot \vert f ( t , {x}_{s} ) \vert + β \cdot cosine\_similarity ( z ( t , {x}_{d} ) , z ( t , {x}_{s} ) )$$

As shown, the total loss may also increase as the similarity between implicit states, z, of ƒ(t, x_{d}) and ƒ(t, xₛ) increase. This similarity is quantified in the total loss equation above using the cosine similarity function. Parameters a and β represent hyperparameters that may be tuned for different training scenarios.

Workflow 200 then proceeds to modify weights 220 (e.g., for neural ODE 208-1 and neural ODE 208-2) and weights 218 (e.g., for spatial-temporal attention module 204) based on the total loss 216. For example, weights 220 and weights 218 may be modified/optimized jointly during training.

The training illustrated in workflow 200 of FIG. 2A may be repeated for all training data instances and/or until spatial-temporal module 204 and neural ODE 208-1's performance is deemed satisfactory. Once spatial-temporal module 204 and neural ODE 208-1's performance is deemed satisfactory, then spatial-temporal module 204 and neural ODE 208-1 (along with ODE solver 209-1) may be deployed for flow estimation in dynamic scene(s). In certain instances, spatial-temporal module 204 and/or neural ODE 208-1 may be updated in some manner, e.g., all or part of spatial-temporal module 204 and/or neural ODE 208-1 may be changed or replaced, or undergo further training, just to name a few examples.

In certain aspects, spatial-temporal module 204 and neural ODE 208-1 may be implemented in regular hardware, including systems on chips (SoCs), to perform flow estimation for dynamic scene(s).

As described above, although aspects herein may be used to model the flow of dynamic points over time, in certain other aspects, neural ODE 208-1 and neural ODE 208-2 may be trained and used to model the dynamic nature of risk-inducing points for risk assessment. Thus, during training for risk assessment, the second branch loss, |ƒ (t, xₛ)|, may be replaced by a nearest distance between a future ego vehicle location and predicted points of the scene. Further, in certain other aspects, neural ODE 208-1 and neural ODE 208-2 may be trained to model points associated with noise for noise removal. Thus, during training for noise removal, the second branch loss, |ƒ(t, xₛ)|, may be replaced by the consistency of the statistical characteristics (e.g., radial mean, radial standard deviation, etc.) of xₛ as some objects (e.g., such as snowflakes) stay a consistent shape near the ego vehicle throughout the sequences, while other objects move relative to the ego vehicle. Put differently, during training, it may be desirable to keep second branch loss small when the outputs are ideal (e.g., being static when modeling the dynamic flow of points, non-colliding for risk assessment, or clean for noise removal). Thus, for risk assessment, the second branch loss may be associated with the inverse of the nearest distance, and for noise removal, the second branch loss may be associated the inconsistency (e.g., variation) of the statistical characteristics.

### Aspects Related to Performing Flow Estimation for Dynamic Scenes

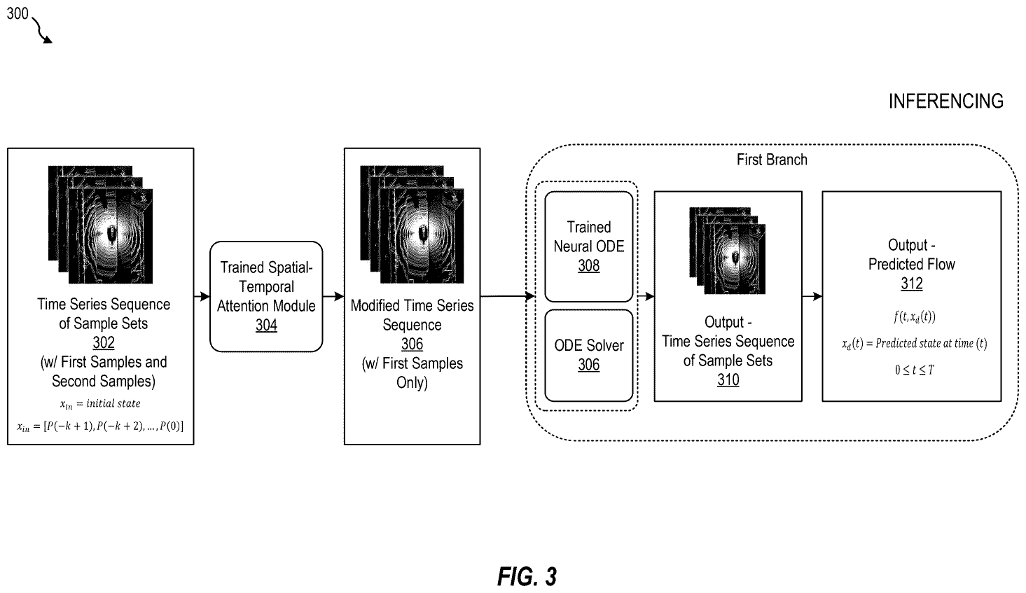

FIG. 3 depicts an example workflow 300 for flow estimation using a trained spatial-temporal attention module 304, a trained neural ODE 308, and an ODE solver 309. In certain aspects, trained spatial-temporal attention module 304 and trained neural ODE 308 may be trained according to workflow 200 in FIG. 2.

Workflow 300 begins by obtaining an input time series sequence of sample sets 302 of a scene (simply referred to herein as “an input time series sequence 302”) over a first period of time (e.g., from time (t₀-k+1) to t₀). Input time series sequence 202 may be an input sequence of scene-level sample sets (e.g., such as point clouds), xᵢₙ, representing the initial state of the scene at time t₀=0 (referred to herein as a “reference time” associated with input time series sequence 302). For example, input time series sequence 202 may include a sequence of k sample sets:

$${x}_{in} ( {t}_{0} ) = [ P ( {t}_{0} ) , P ( {t}_{0} - 1 ) , … , P ( {t}_{0} - k + 1 ) ]$$

Each sample set (e.g., point cloud represented as P(t)) may include multiple samples. In certain aspects, each sample set is a point cloud with multiple points representing a scene at a particular timestamp. In certain aspects, each sample set is an image with multiple pixels representing a scene at a particular timestamp. The samples included in each sample set may include first samples (e.g., such as dynamic samples associated with the scene) and/or second samples (e.g., such as static samples associated with the scene).

In certain aspects, each sample set of input time series sequence 302 may include additional information related to the samples included in the sample sets. For example, the sample sets may include intensity information and/or location information for one or more of the samples.

The input time series sequence 302 may be associated with time to, e.g., a “reference time.”

Workflow 300 then proceeds with trained spatial-temporal attention module 304 processing input time series sequence 202 to generate modified time series sequence 306, x_{d} (e.g., x_{d}(t₀) and x_{d}(0)). For example, trained spatial-temporal attention nodule may be used to partition input time series sequence 302 samples into first samples (e.g., dynamic samples) and second samples (e.g., static samples), select the first samples (e.g., dynamic samples) from input time series sequence 302 samples, and use these dynamic samples to generate modified time series sequence 306, x_{d}. Modified time series sequence 306, x_{d}, may include a sequence of sample sets representing the scene, associated with reference time (e.g., time t₀), and including only the first samples (e.g., does not include the second samples (e.g., the static samples)).

Workflow 300 proceeds with trained neural ODE 308 and ODE solver 309 processing modified time series sequence 306, x_{d}, to predict an output time series sequence of sample sets 310 (simply “output time series sequence 310”). In certain aspects, feature extraction is performed to extract implicit states (e.g., z(t, x_{d})) from modified time series sequence 306, x_{d}, and use these implicit states to predict the output time series sequence 310. The implicit states may include information about intentions of points and/or interactions between points in modified time series sequence 306, x_{d}. In certain aspects, the implicit states (e.g., z(t, x_{d})) may be used to infer resulting motions of the different points to determine movement of one or more agents in the scene for determining goal(s) of the agent(s). In certain aspects, the implicit states (e.g., z(t, x_{d})) may be used for motion classification (e.g. such as determining if a pedestrian wants to cross the road or not) by using the implicit states as inputs to another classification network.

Output time series sequence 310 may include a sequence of sample sets (e.g., such as point clouds) that represent the state of the scene from the reference time, t₀=0, to time t₁=T (e.g., a period of time, T, in the future). More specifically, the sample sets (e.g., point clouds) may represent motion of the first samples (e.g., dynamic samples) in the scene between time 0-T. The output time series sequence 310 may include information about (1) 3D position changes, (2) intentions, and/or (3) goals associated with the first samples.

In certain aspects, a temporal resolution (δ₂) of output time series sequence 310 may be different than a temporal resolution (δ₁) of modified time series sequence 306. In certain aspects, the temporal resolution (δ₂) of output time series sequence 310 may be chosen to be relatively small (e.g., δ2=0.01) to provide a more accurate depiction of the motion of points in the scene over time T.

A predicted flow 312 at time t (e.g., 0≤t≤T) may be determined using the input time series sequence 302 and output time series sequence 310. For example, the state of the scene at time t may be estimated as (e.g., using ODE solver 309):

$${x}_{d} ( t ) = ODEsolver ( f , {x}_{in} , {t}_{0} = 0 , {t}_{1} = T )$$

and the scene flow at time t may be estimated by comparing x_{d}(t) to x_{d}(0):

$$SceneFlow ( t ) = {x}_{d} ( t ) - {x}_{d} ( 0 )$$

The scene flow at any time t may be determined by comparing x_{d}(t) and x_{d}(0). This estimated scene flow for the dynamic scene may be used in various downstream applications, such as applications for autonomous driving and/or robotics.

### Example Artificial Intelligence System for Generating a Trajectory

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an autonomous vehicle navigation system.

ML models may be deployed in one or more devices (e.g., autonomous vehicles, devices, or other intelligent agents) to support various aspects of scene flow estimation. For example, a spatial temporal attention module and a neural ODE may be used to identify dynamic samples collected for a scene over a period of time and use these dynamic samples to model flow of the scene as a continuous-time dynamical system.

Aspects described herein may describe the performance of certain tasks and the technical solution of various technical problems by application of a spatial-temporal attention module and a neural ODE. It should be understood, however, that other type(s) of AI models may be used. Further, it should be understood that, unless otherwise specifically stated, terms such “AI model,” “ML model,” “AI/ML model,” “trained ML model,” and the like are intended to be interchangeable.

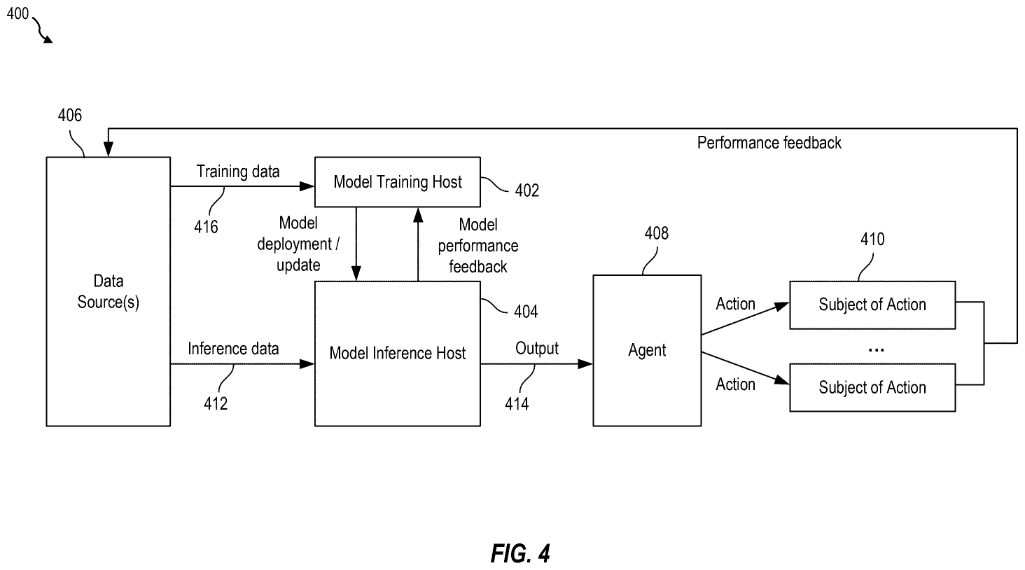

FIG. 4 is a diagram illustrating an example AI architecture 400 that may be used to implement the machine learning models and scene flow estimation techniques discussed herein. As illustrated, the architecture 400 includes multiple logical entities, such as a model training host 402 for training the machine learning model, a model inference host 404 for running inference using the trained model, data source(s) 406 providing training and inference data, and an agent 408 that utilizes the model's output. This AI architecture could be used to enable example scene flow estimation techniques in various autonomous systems.

The model inference host 404, in the architecture 400, is configured to run an ML model based on inference data 412 provided by data source(s) 406. The model inference host 404 may produce an output 414 (e.g., a predicted scene flow) based on the inference data 412, that is then provided as input to the agent 408.

The agent 408 may be an element or entity that utilizes the output of the machine learning model hosted by the model inference host 404. The agent 408 may be an autonomous vehicle, a robot, a device, or any other intelligent system that leverages the scene flow estimated by the model for navigation and decision-making.

For example, if the output 414 from the model inference host 404 is an estimated flow of objects in a scene, then agent 408 may be an autonomous vehicle that uses the scene flow estimation for navigating in its environment. As another example, if the output 414 is an estimated flow of objects in a scene, then agent 408 may be a robot, or other device, that selects the best path to take in the scene based on its current goals and executes it.

After receiving the output 414 from the model inference host 404, the agent 408 may determine how to utilize it. For instance, if the agent 408 is an autonomous vehicle and the output is estimated flow for a scene, it may use the estimate scene flow to control its actuators and navigate safely. If the agent 408 decides to use the output 414, it may apply it to the subject of the action 410, which represents the environment or system being acted upon. In the autonomous vehicle example, the subject of action 410 would be the vehicle's motion control system. In some cases, the agent 408 and subject of action 410 may be tightly integrated.

The data sources 406 may be configured for collecting data that is used as training data 416 for training the machine learning model. The data sources 406 may also provide inference data 412 (also referred to as input data) for feeding the trained model during inference. In particular, the data sources 406 may collect data relevant to the scene flow estimation task depicted in FIG. 3, such as 3D and/or 2D sensor data (e.g., 3D point clouds, 2D images, etc.). This data may come from various sources, including the subject of action 410, which represents the environment or system being acted upon by the model. The collected data is provided to the model training host 402 for training and fine-tuning the trajectory planning model. For example, after the subject of action 410 (e.g., an autonomous vehicle) executes a planned trajectory, the resulting sensor data and feedback may be compared to the expected outcome to evaluate the model's performance. If the output 414 is not sufficiently accurate or safe, this performance feedback may be used by the model training host 402 to further train the model thereby aiming to improve its planning capabilities. The updated model may then be deployed to the model inference host 404.

In certain aspects, the model training host 402 may be deployed at or with the same or a different entity than that in which the model inference host 404 is deployed. For example, in order to offload model training processing, which can impact the performance of the model inference host 404, the model training host 402 may be deployed at a model server. Further, in some cases, training and/or inference may be distributed amongst devices in a decentralized or federated fashion.

In some aspects, a machine learning model trained to perform scene flow estimation is deployed at or on a computing device for enhancing the performance of scene flow estimation tasks. More specifically, a model inference host, such as model inference host 404 in FIG. 4, may be deployed at or on the computing device for running the spatial-temporal attention module, the neural ODE, and the ODE solver to estimate flow for dynamic scene(s).

In some other aspects, the spatial-temporal attention module, the neural ODE, and the ODE solver may be deployed at or on an embedded system, a mobile robot, or another device for enabling efficient scene flow estimation. More specifically, a model inference host, such as model inference host 404 in FIG. 4, may be deployed at or on the embedded system, mobile robot, or other device for running the model to model the continuous flow in dynamic scene(s).

### Example Operations for Flow Estimation for Dynamic Scenes

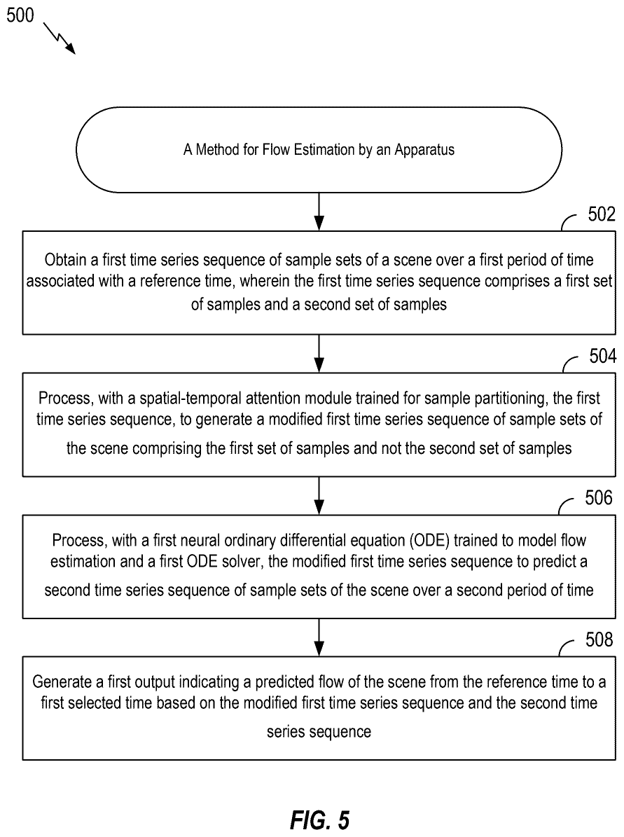

FIG. 5 depicts an example method 500 for flow estimation by an apparatus. For example, the apparatus may perform method 500 to predict the flow.

Method 500 begins, at block 502, with obtaining a first time series sequence of sample sets of a scene over a first period of time associated with a reference time. The first time series sequence may include a first set of samples and a second set of samples.

Method 500 proceeds, at block 504, with processing, with a spatial-temporal attention module trained for sample partitioning, the first time series sequence, to generate a modified first time series sequence of sample sets of the scene comprising the first set of samples and not the second set of samples.

Method 500 proceeds, at block 506, with processing, with a first neural ODE trained to model flow estimation and a first ODE solver, the modified first time series sequence to predict a second time series sequence of sample sets of the scene over a second period of time.

Method 500 proceeds, at block 508, with generating a first output indicating a predicted flow of the scene from the reference time to a first selected time based on the modified first time series sequence and the second time series sequence.

In certain aspects, the first time series sequence and the modified first time series sequence are associated with a first temporal resolution. In certain aspects, the second time series sequence is associated with a second temporal resolution different than the first temporal resolution.

In certain aspects, method 500 further includes jointly training the spatial-temporal attention module for sample partitioning and the first neural ODE to model flow estimation.

In certain aspects, jointly training the spatial-temporal attention module and the first neural ODE includes: initializing one or more first weights for the spatial-temporal attention module; initializing one or more second weights for the first neural ODE and a second neural ODE; obtaining a plurality of training input time series sequences of sample sets of a training scene, wherein: each respective training input time series sequence comprises a respective set of first training samples and a respective set of second training samples; and each respective training input time series sequence is associated with a respective training reference time; for each respective training input time series sequence: processing, with the spatial-temporal attention module, the respective training input time series sequence to generate: a respective first modified training input time series sequence comprising the respective set of first training samples and not the respective set of second training samples; and a respective second modified training input time series sequence comprising the respective set of second training samples and not the respective set of first training samples; processing, with the first neural ODE and the first ODE solver, the respective first modified training input time series sequence to predict a respective first training output time series sequence of sample sets; generating a respective first training output indicating a respective first predicted flow of the training scene from the respective training reference time to a respective second selected time based on the respective first modified training input time series sequence and the respective first training output time series sequence; processing, with the second neural ODE and a second ODE solver, the respective second modified training input time series sequence to predict a respective second training output time series sequence of sample sets; generating a respective second training output indicating a respective second predicted flow of the training scene from the respective training reference time to the respective second selected time based on the respective second modified training input time series sequence and the respective second training output time series sequence; determining a respective loss value based on the respective first training output and the respective second training output; and based on the respective loss value, modifying: the one or more first weights; and the one or more second weights.

In certain aspects, each respective first training output time series sequence of sample sets includes information about a respective first set of at least one of intentions or goals associated with the respective set of first training samples. In certain aspects, each respective second training output time series sequence of sample sets includes information about a respective second set of at least one of intentions or goals associated with the respective set of second training samples. In certain aspects, determining each respective loss value includes determining the respective loss value using a loss function configured to: increase the respective loss value as the respective second training output increases; and increase the respective loss value as similarity between the respective first set of intentions or goals and the respective second set of intention or goals increases.

In certain aspects, processing, with the spatial-temporal attention module, the first time series sequence to generate the modified first time series sequence at block 504 includes: generating a plurality of attention maps, each attention map indicating a tendency of activity for one or more samples in the first set of samples and the second set of samples.

In certain aspects, the second time series sequence includes information about at least one of: position changes associated with the first set of samples; intentions associated with the first set of samples; or goals associated with the first set of samples.

In certain aspects, the first time series sequence further includes at least one of: intensity information for at least one of the first set of samples or the second set of samples; or location information for at least one of the first set of samples or the second set of samples.

In certain aspects, the first time series sequence of sample sets includes: a plurality of point clouds; or a plurality of images.

In certain aspects, the first set of samples includes a plurality of dynamic samples; and the second set of samples comprises a plurality of static samples.

In certain aspects, the first set of samples includes a plurality of risk-inducing samples. In certain aspects, the second set of samples includes a plurality of non-risk-inducing samples.

In certain aspects, the first set of samples includes a plurality of samples associated with noise. In certain aspects, the second set of samples includes a plurality of samples not associated with noise.

Note that FIG. 5 is just one example of a method, and other methods including fewer, additional, or alternative steps are possible consistent with this disclosure.

### Example Operations for Flow Estimation Training

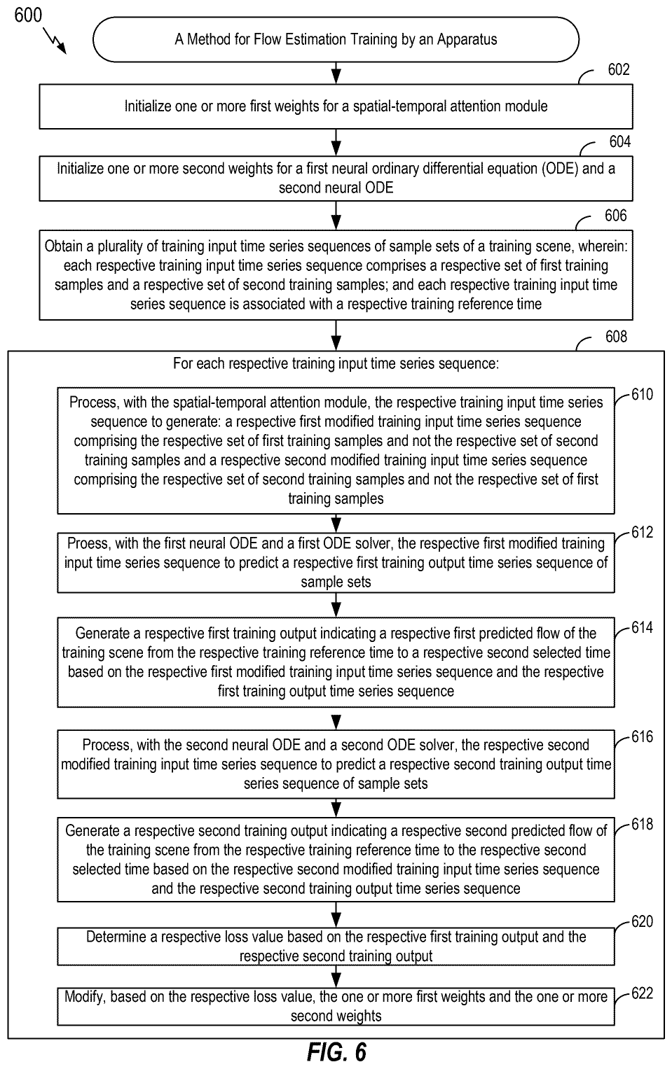

FIG. 6 depicts an example method 600 for flow estimation training by an apparatus. For example, the apparatus may perform method 600 to train a spatial-temporal attention module (e.g., such as spatial-temporal attention module 204 in FIG. 2A) and an ODE (e.g., such as first neural ODE 208-1 in FIG. 2A) to determine flow estimation for dynamic scenes.

Method 600 begins, at block 602, with initializing one or more first weights for a spatial-temporal attention module.

Method 600 proceeds, at block 604, with initializing one or more second weights for a first neural ODE and a second neural ODE.

Method 600 proceeds, at block 606, with obtaining a plurality of training input time series sequences of sample sets of a training scene. Each respective training input time series sequence may include a respective set of first training samples and a respective set of second training samples. Each respective training input time series sequence may be associated with a respective training reference time.

Method 600 proceeds, at block 608, with for each respective training input time series sequence, performing operations at blocks 610-622.

For example, method 600 proceeds, at block 610, with processing, with the spatial-temporal attention module, the respective training input time series sequence to generate: a respective first modified training input time series sequence comprising the respective set of first training samples and not the respective set of second training samples and a respective second modified training input time series sequence comprising the respective set of second training samples and not the respective set of first training samples.

Method 600 proceeds, at block 612, with processing, with the first neural ODE and a first ODE solver, the respective first modified training input time series sequence to predict a respective first training output time series sequence of sample sets.

Method 600 proceeds, at block 614, with generating a respective first training output indicating a respective first predicted flow of the training scene from the respective training reference time to a respective second selected time based on the respective first modified training input time series sequence and the respective first training output time series sequence.

Method 600 proceeds, at block 616, with processing, with the second neural ODE and a second ODE solver, the respective second modified training input time series sequence to predict a respective second training output time series sequence of sample sets.

Method 600 proceeds, at block 618, with generating a respective second training output indicating a respective second predicted flow of the training scene from the respective training reference time to the respective second selected time based on the respective second modified training input time series sequence and the respective second training output time series sequence.

Method 600 proceeds, at block 620, with determining a respective loss value based on the respective first training output and the respective second training output.

Method 600 proceeds, at block 622, with modifying, based on the respective loss value, the one or more first weights and the one or more second weights.

Note that FIG. 6 is just one example of a method, and other methods including fewer, additional, or alternative steps are possible consistent with this disclosure.

### Example Device for Flow Estimation for Dynamic Scenes

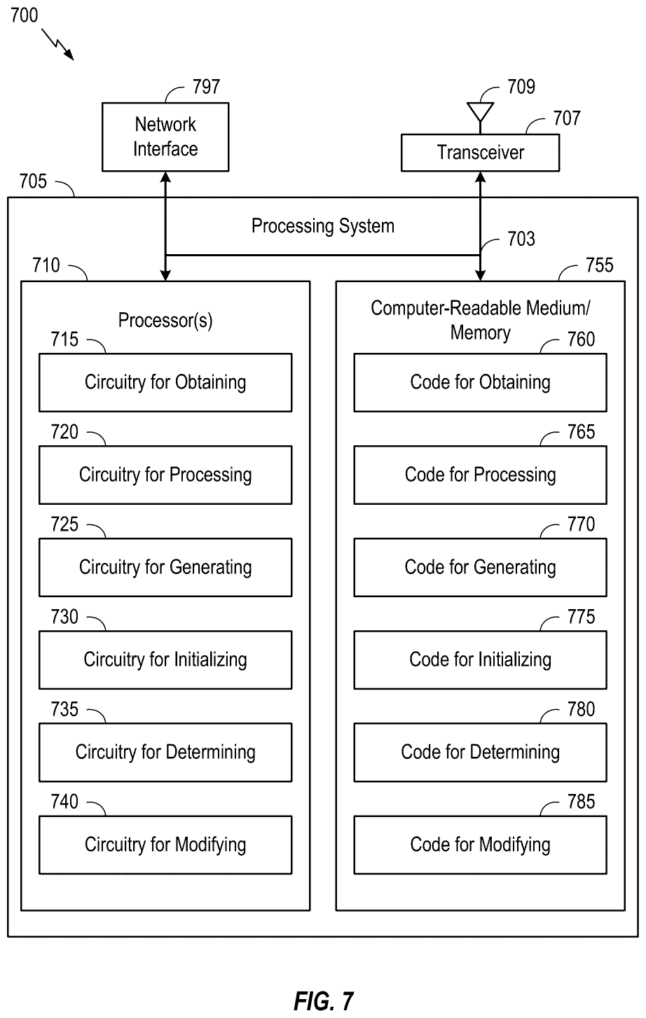

FIG. 7 depicts aspects of an example device 700 configured to perform flow estimation for dynamic scenes.

Device 700 includes a processing system 705. In certain aspects, processing system 705 may be coupled to a transceiver 707 (e.g., a transmitter and/or a receiver) and/or a network interface 797. The transceiver 707 may be configured to transmit and receive signals for the device 700 via an antenna 709, such as the various signals as described herein. The network interface 797 may be configured to obtain and send signals for the device 700 via communications link(s).

The processing system 705 includes one or more processors 710. The one or more processors 710 are coupled to a computer-readable medium/memory 755 via a bus 703. In certain aspects, the computer-readable medium/memory 755 is configured to store instructions (e.g., computer-executable code), including code 760-785, that when executed by the one or more processors 710, enable and cause the one or more processors 710 to perform the method 500 described with respect to FIG. 5, method 600 described with respect to FIG. 6, and/or any aspect related to method 500 and/or method 600, including any operations described in relation to FIGS. 2A and 3. Note that reference to a processor of device 700 performing a function may include one or more processors of device 700 performing that function, such as in a distributed fashion.

In the depicted example, the computer-readable medium/memory 755 stores code 760 for obtaining, code 765 for processing, code 770 for generating, code 775 for initializing, code 780 for determining, and code 785 for modifying. Processing of the code 760-785 may enable and cause the device 700 to perform the method 500 described with respect to FIG. 5, method 600 described with respect to FIG. 6, and/or any aspect related to method 500 and/or method 600.

The one or more processors 710 include circuitry configured to implement (e.g., execute) the code (e.g., executable instructions) stored in the computer-readable medium/memory 755, including circuitry 715 for obtaining, circuitry 720 for processing, circuitry 725 for generating, circuitry 730 for initializing, circuitry 735 for determining, and circuitry 740 for modifying. Processing with circuitry 715-740 may enable and cause the device 700 to perform the method 500 described with respect to FIG. 5, method 600 described with respect to FIG. 6, and/or any aspect related to method 500 and/or method 600.

Various components of the device 700 may provide means for performing the method 500 described with respect to FIG. 5, method 600 described with respect to FIG. 6, and/or any aspect related to method 500 and/or method 600. For example, means for obtaining, processing, generating, initializing, determining, and/or modify of the method 500 described with respect to FIG. 5, method 600 described with respect to FIG. 6, and/or any aspect related to method 500 and/or method 600 may include one or more processors 710 of the device 700 in FIG. 7.

### Example Clauses

Implementation examples are described in the following numbered clauses:

Clause 1: A method of flow estimation by an apparatus, comprising: obtaining a first time series sequence of sample sets of a scene over a first period of time associated with a reference time, wherein the first time series sequence comprises a first set of samples and a second set of samples; processing, with a spatial-temporal attention module trained for sample partitioning, the first time series sequence, to generate a modified first time series sequence of sample sets of the scene comprising the first set of samples and not the second set of samples; processing, with a first neural ordinary differential equation (ODE) trained to model flow estimation and a first ODE solver, the modified first time series sequence to predict a second time series sequence of sample sets of the scene over a second period of time; and generating a first output indicating a predicted flow of the scene from the reference time to a first selected time based on the modified first time series sequence and the second time series sequence.

Clause 2: The method of Clause 1, wherein: the first time series sequence and the modified first time series sequence are associated with a first temporal resolution; and the second time series sequence is associated with a second temporal resolution different than the first temporal resolution.

Clause 3: The method of any one of Clauses 1-2, further comprising: jointly training the spatial-temporal attention module for sample partitioning and the first neural ODE to model flow estimation.

Clause 4: The method of Clause 3, wherein jointly training the spatial-temporal attention module and the first neural ODE comprises: initializing one or more first weights for the spatial-temporal attention module; initializing one or more second weights for the first neural ODE and a second neural ODE; obtaining a plurality of training input time series sequences of sample sets of a training scene, wherein: each respective training input time series sequence comprises a respective set of first training samples and a respective set of second training samples; and each respective training input time series sequence is associated with a respective training reference time; for each respective training input time series sequence: processing, with the spatial-temporal attention module, the respective training input time series sequence to generate: a respective first modified training input time series sequence comprising the respective set of first training samples and not the respective set of second training samples; and a respective second modified training input time series sequence comprising the respective set of second training samples and not the respective set of first training samples; processing, with the first neural ODE and the first ODE solver, the respective first modified training input time series sequence to predict a respective first training output time series sequence of sample sets; generating a respective first training output indicating a respective first predicted flow of the training scene from the respective training reference time to a respective second selected time based on the respective first modified training input time series sequence and the respective first training output time series sequence; processing, with the second neural ODE and a second ODE solver, the respective second modified training input time series sequence to predict a respective second training output time series sequence of sample sets; generating a respective second training output indicating a respective second predicted flow of the training scene from the respective training reference time to the respective second selected time based on the respective second modified training input time series sequence and the respective second training output time series sequence; determining a respective loss value based on the respective first training output and the respective second training output; and based on the respective loss value, modifying: the one or more first weights; and the one or more second weights.

Clause 5: The method of Clause 4, wherein: each respective first training output time series sequence of sample sets comprises information about a respective first set of at least one of intentions or goals associated with the respective set of first training samples; each respective second training output time series sequence of sample sets comprises information about a respective second set of at least one of intentions or goals associated with the respective set of second training samples; and determining each respective loss value comprises determining the respective loss value using a loss function configured to: increase the respective loss value as the respective second training output increases; and increase the respective loss value as similarity between the respective first set of intentions or goals and the respective second set of intention or goals increases.

Clause 6: The method of any one of Clauses 1-5, wherein processing, with the spatial-temporal attention module, the first time series sequence to generate the modified first time series sequence comprises: generating a plurality of attention maps, each attention map indicating a tendency of activity for one or more samples in the first set of samples and the second set of samples.

Clause 7: The method of any one of Clauses 1-6, wherein the second time series sequence comprises information about at least one of: position changes associated with the first set of samples; intentions associated with the first set of samples; or goals associated with the first set of samples.

Clause 8: The method of any one of Clauses 1-7, wherein the first time series sequence further comprises at least one of: intensity information for at least one of the first set of samples or the second set of samples; or location information for at least one of the first set of samples or the second set of samples.

Clause 9: The method of any one of Clauses 1-8, wherein the first time series sequence of sample sets comprises: a plurality of point clouds; or a plurality of images.

Clause 10: The method of any one of Clauses 1-9, wherein: the first set of samples comprises a plurality of dynamic samples; and the second set of samples comprises a plurality of static samples.

Clause 11: The method of any one of Clauses 1-10, wherein: the first set of samples comprises a plurality of risk-inducing samples; and the second set of samples comprises a plurality of non-risk-inducing samples.

Clause 12: The method of any one of Clauses 1-11, wherein: the first set of samples comprises a plurality of samples associated with noise; and the second set of samples comprises a plurality of samples not associated with noise.

Clause 13: A method for flow estimation training by an apparatus, comprising: initializing one or more first weights for a spatial-temporal attention module; initializing one or more second weights for a first neural ordinary differential equation (ODE) and a second neural ODE; obtaining a plurality of training input time series sequences of sample sets of a training scene, wherein: each respective training input time series sequence comprises a respective set of first training samples and a respective set of second training samples; and each respective training input time series sequence is associated with a respective training reference time; for each respective training input time series sequence: processing, with the spatial-temporal attention module, the respective training input time series sequence to generate: a respective first modified training input time series sequence comprising the respective set of first training samples and not the respective set of second training samples; and a respective second modified training input time series sequence comprising the respective set of second training samples and not the respective set of first training samples; processing, with the first neural ODE and a first ODE solver, the respective first modified training input time series sequence to predict a respective first training output time series sequence of sample sets; generating a respective first training output indicating a respective first predicted flow of the training scene from the respective training reference time to a respective second selected time based on the respective first modified training input time series sequence and the respective first training output time series sequence; processing, with the second neural ODE and a second ODE solver, the respective second modified training input time series sequence to predict a respective second training output time series sequence of sample sets; generating a respective second training output indicating a respective second predicted flow of the training scene from the respective training reference time to the respective second selected time based on the respective second modified training input time series sequence and the respective second training output time series sequence; determining a respective loss value based on the respective first training output and the respective second training output; and based on the respective loss value, modifying the one or more first weights and the one or more second weights.

Clause 14: One or more apparatuses, comprising: one or more memories comprising executable instructions; and one or more processors configured to execute the executable instructions and cause the one or more apparatuses to perform a method in accordance with any one of clauses 1-13.

Clause 15: One or more apparatuses, comprising: one or more memories; and one or more processors, coupled to the one or more memories, configured to cause the one or more apparatuses to perform a method in accordance with any one of Clauses 1-13.

Clause 16: One or more apparatuses, comprising: one or more memories; and one or more processors, coupled to the one or more memories, configured to perform a method in accordance with any one of Clauses 1-13.

Clause 17: One or more apparatuses, comprising means for performing a method in accordance with any one of Clauses 1-13.

Clause 18: One or more non-transitory computer-readable media comprising executable instructions that, when executed by one or more processors of one or more apparatuses, cause the one or more apparatuses to perform a method in accordance with any one of Clauses 1-13.

Clause 19: One or more computer program products embodied on one or more computer-readable storage media comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising:
one or more memories; and
one or more processors, coupled to the one or more memories, configured to cause the apparatus to:
obtain a first time series sequence of sample sets of a scene over a first period of time associated with a reference time, wherein the first time series sequence comprises a first set of samples and a second set of samples;
process, with a spatial-temporal attention module trained for sample partitioning, the first time series sequence, to generate a modified first time series sequence of sample sets of the scene comprising the first set of samples and not the second set of samples;
process, with a first neural ordinary differential equation (ODE) trained to model flow estimation and a first ODE solver, the modified first time series sequence to predict a second time series sequence of sample sets of the scene over a second period of time; and
generate a first output indicating a predicted flow of the scene from the reference time to a first selected time based on the modified first time series sequence and the second time series sequence.

2. The apparatus of claim 1, wherein:
the first time series sequence and the modified first time series sequence are associated with a first temporal resolution; and
the second time series sequence is associated with a second temporal resolution different than the first temporal resolution.

3. The apparatus of claim 1, wherein the one or more processors are configured to cause the apparatus to jointly train:
the spatial-temporal attention module for sample partitioning; and
the first neural ODE to model flow estimation.

4. The apparatus of claim 3, wherein to jointly train the spatial-temporal attention module and the first neural ODE, the one or more processors are configured to cause the apparatus to:
initialize one or more first weights for the spatial-temporal attention module;
initialize one or more second weights for the first neural ODE and a second neural ODE;
obtain a plurality of training input time series sequences of sample sets of a training scene, wherein:
each respective training input time series sequence comprises a respective set of first training samples and a respective set of second training samples; and
each respective training input time series sequence is associated with a respective training reference time;
for each respective training input time series sequence:
process, with the spatial-temporal attention module, the respective training input time series sequence to generate:
a respective first modified training input time series sequence comprising the respective set of first training samples and not the respective set of second training samples; and
a respective second modified training input time series sequence comprising the respective set of second training samples and not the respective set of first training samples;
process, with the first neural ODE and the first ODE solver, the respective first modified training input time series sequence to predict a respective first training output time series sequence of sample sets;
generate a respective first training output indicating a respective first predicted flow of the training scene from the respective training reference time to a respective second selected time based on the respective first modified training input time series sequence and the respective first training output time series sequence;
process, with the second neural ODE and a second ODE solver, the respective second modified training input time series sequence to predict a respective second training output time series sequence of sample sets;
generate a respective second training output indicating a respective second predicted flow of the training scene from the respective training reference time to the respective second selected time based on the respective second modified training input time series sequence and the respective second training output time series sequence;
determine a respective loss value based on the respective first training output and the respective second training output; and
based on the respective loss value, modify:
the one or more first weights; and
the one or more second weights.

5. The apparatus of claim 4, wherein:
each respective first training output time series sequence of sample sets comprises information about a respective first set of at least one of intentions or goals associated with the respective set of first training samples;
each respective second training output time series sequence of sample sets comprises information about a respective second set of at least one of intentions or goals associated with the respective set of second training samples; and
to determine each respective loss value, the one or more processors are configured to cause the apparatus to determine the respective loss value using a loss function configured to:
increase the respective loss value as the respective second training output increases; and
increase the respective loss value as similarity between the respective first set of intentions or goals and the respective second set of intention or goals increases.

6. The apparatus of claim 1, wherein to process, with the spatial-temporal attention module, the first time series sequence to generate the modified first time series sequence, the one or more processors are configured to cause the apparatus to:
generate a plurality of attention maps, each attention map indicating a tendency of activity for one or more samples in the first set of samples and the second set of samples.

7. The apparatus of claim 1, wherein the second time series sequence comprises information about at least one of:
position changes associated with the first set of samples;
intentions associated with the first set of samples; or
goals associated with the first set of samples.

8. The apparatus of claim 1, wherein the first time series sequence further comprises at least one of:
intensity information for at least one of the first set of samples or the second set of samples; or
location information for at least one of the first set of samples or the second set of samples.

9. The apparatus of claim 1, wherein the first time series sequence of sample sets comprises:
a plurality of point clouds; or
a plurality of images.

10. The apparatus of claim 1, wherein:
the first set of samples comprises a plurality of dynamic samples; and
the second set of samples comprises a plurality of static samples.

11. The apparatus of claim 1, wherein:
the first set of samples comprises a plurality of risk-inducing samples; and
the second set of samples comprises a plurality of non-risk-inducing samples.

12. The apparatus of claim 1, wherein:
the first set of samples comprises a plurality of samples associated with noise; and
the second set of samples comprises a plurality of samples not associated with noise.

13. A method for flow estimation by an apparatus, comprising:
obtaining a first time series sequence of sample sets of a scene over a first period of time associated with a reference time, wherein the first time series sequence comprises a first set of samples and a second set of samples;
processing, with a spatial-temporal attention module trained for sample partitioning, the first time series sequence, to generate a modified first time series sequence of sample sets of the scene comprising the first set of samples and not the second set of samples;
processing, with a first neural ordinary differential equation (ODE) trained to model flow estimation and a first ODE solver, the modified first time series sequence to predict a second time series sequence of sample sets of the scene over a second period of time; and
generating a first output indicating a predicted flow of the scene from the reference time to a first selected time based on the modified first time series sequence and the second time series sequence.

14. The method of claim 13, wherein:
the first time series sequence and the modified first time series sequence are associated with a first temporal resolution; and
the second time series sequence is associated with a second temporal resolution different than the first temporal resolution.

15. The method of claim 13, further comprising:
jointly training the spatial-temporal attention module for sample partitioning and the first neural ODE to model flow estimation.

16. The method of claim 15, jointly training the spatial-temporal attention module and the first neural ODE comprises:
initializing one or more first weights for the spatial-temporal attention module;
initializing one or more second weights for the first neural ODE and a second neural ODE;
obtaining a plurality of training input time series sequences of sample sets of a training scene, wherein:
each respective training input time series sequence comprises a respective set of first training samples and a respective set of second training samples; and
each respective training input time series sequence is associated with a respective training reference time;
for each respective training input time series sequence:
processing, with the spatial-temporal attention module, the respective training input time series sequence to generate:
a respective first modified training input time series sequence comprising the respective set of first training samples and not the respective set of second training samples; and
a respective second modified training input time series sequence comprising the respective set of second training samples and not the respective set of first training samples;
processing, with the first neural ODE and the first ODE solver, the respective first modified training input time series sequence to predict a respective first training output time series sequence of sample sets;
generating a respective first training output indicating a respective first predicted flow of the training scene from the respective training reference time to a respective second selected time based on the respective first modified training input time series sequence and the respective first training output time series sequence;
processing, with the second neural ODE and a second ODE solver, the respective second modified training input time series sequence to predict a respective second training output time series sequence of sample sets;
generating a respective second training output indicating a respective second predicted flow of the training scene from the respective training reference time to the respective second selected time based on the respective second modified training input time series sequence and the respective second training output time series sequence;
determining a respective loss value based on the respective first training output and the respective second training output; and
based on the respective loss value, modifying:
the one or more first weights; and
the one or more second weights.

17. The method of claim 16, wherein:
each respective first training output time series sequence of sample sets comprises information about a respective first set of at least one of intentions or goals associated with the respective set of first training samples;
each respective second training output time series sequence of sample sets comprises information about a respective second set of at least one of intentions or goals associated with the respective set of second training samples; and
determining each respective loss value comprises determining the respective loss value using a loss function configured to:
increase the respective loss value as the respective second training output increases; and
increase the respective loss value as similarity between the respective first set of intentions or goals and the respective second set of intention or goals increases.

18. The method of claim 13, wherein processing, with the spatial-temporal attention module, the first time series sequence to generate the modified first time series sequence comprises:
generating a plurality of attention maps, each attention map indicating a tendency of activity for one or more samples in the first set of samples and the second set of samples.

19. The method of claim 13, wherein the second time series sequence comprises information about at least one of:
position changes associated with the first set of samples;
intentions associated with the first set of samples; or
goals associated with the first set of samples.

20. One or more non-transitory computer-readable media comprising executable instructions that, when executed by one or more processors of an apparatus, cause the apparatus to perform operations comprising:
obtaining a first time series sequence of sample sets of a scene over a first period of time associated with a reference time, wherein the first time series sequence comprises a first set of samples and a second set of samples;
processing, with a spatial-temporal attention module trained for sample partitioning, the first time series sequence, to generate a modified first time series sequence of sample sets of the scene comprising the first set of samples and not the second set of samples;
processing, with a first neural ordinary differential equation (ODE) trained to model flow estimation and a first ODE solver, the modified first time series sequence to predict a second time series sequence of sample sets of the scene over a second period of time; and
generating a first output indicating a predicted flow of the scene from the reference time to a first selected time based on the modified first time series sequence and the second time series sequence.
